(19) United States
(12) Patent Application Publication
(10) Pub. No.: US 2022/0044572 A1
(43) Pub. Date: Feb. 10, 2022

(54) VEHICLE DISPATCH SYSTEM, SERVER, AND VEHICLE DISPATCH METHOD

(71) Applicant: Toyota Jidosha Kabushiki Kaisha, Toyota-shi Aichi-ken (JP)

(72) Inventors: Shin Sakurada, Toyota-shi (JP); Shintaro Matsutani, Kariya-shi (JP); Bryce H. Morisako, Frisco, TX (US); Joshua Babcock, Dallas, TX (US)

(21) Appl. No.: 17/394,889

(22) Filed: Aug. 5, 2021

(30) Foreign Application Priority Data
Aug. 7, 2020 (JP) 2020-135382

(51) Int. Cl. G08G 1/00; G06Q 10/06; B60W 50/00; B60W 60/00; G06Q 50/30; G06N 20/00

(52) U.S. Cl. CPC G08G 1/202; G06Q 10/06315; B60W 50/0097; B60W 2050/0095; G06Q 50/30; G06N 20/00; B60W 60/0025

(57) ABSTRACT

A vehicle dispatch system includes a server and a plurality of vehicles. Each vehicle in the plurality of vehicles includes a vehicle communication interface configured to be able to transmit/receive information to/from the server, and a cabin used for a service to a user. The server includes a server communication interface and a server controller. The server communication interface is configured to be able to transmit/receive information to/from the plurality of vehicles. The server controller is configured to perform demand forecasting for a plurality of services, determine a mode of the cabin of the specific vehicle based on a result of the demand forecasting, and instruct the specific vehicle to perform a mode change to the determined mode via the server communication interface.

### CROSS-REFERENCE TO RELATED APPLICATION

This application claims priority to Japanese Patent Application No. 2020-135382 filed on Aug. 7, 2020, the entire contents of which are incorporated herein by reference.

### TECHNICAL FIELD

The present disclosure relates to a vehicle dispatch system, a server, and a vehicle dispatch method.

### BACKGROUND

Ride sharing systems for dispatching suitable types of vehicles in accordance with various transport conditions, such as the weather, roads for driving, the number of passengers, or type and quantity of cargo, have been disclosed (for example, Patent Literature [PTL] 1). In these systems, if the weather is bad, open-top vehicles are not dispatched, and vehicles that can drive safely on rough roads are provided even when the vehicles are used for, for example, journeys.

### CITATION LIST

### Patent Literature

PTL 1: US 2016-0187150 A

### SUMMARY

In order to prepare vehicles in a way that accommodates all transport conditions, however, an enormous number and types of vehicles need to be prepared, and it is likely that operation rates of some vehicles decline.

It would be helpful to provide a vehicle dispatch system, a server, and a vehicle dispatch method that are capable of efficiently responding to demands for dispatch of vehicles without the need to prepare a number of vehicles.

A vehicle dispatch system according to an embodiment of the present disclosure includes a server and a plurality of vehicles. Each vehicle in the plurality of vehicles includes a vehicle communication interface configured to be able to transmit/receive information to/from the server, and a cabin used for a service to a user. The plurality of vehicles include a specific vehicle, a mode of the cabin of the specific vehicle being selectable from a plurality of modes. The server includes a server communication interface and a server controller. The server communication interface is configured to transmit/receive information to/from the plurality of vehicles. The server controller is configured to perform demand forecasting for a plurality of services, determine the mode of the cabin of the specific vehicle based on a result of the demand forecasting, and instruct the specific vehicle to perform a mode change to the determined mode via the server communication interface.

A server according to an embodiment of the present disclosure is a server for use in a vehicle dispatch system including the server and a plurality of vehicles, and the server includes a server communication interface and a server controller. The server communication interface is configured to be able to transmit/receive information to and from the plurality of vehicles. The plurality of vehicles include a specific vehicle, a mode of a cabin of the specific vehicle being selectable from a plurality of modes, the cabin being used for a service to a user. The server controller is configured to perform demand forecasting for a plurality of services, determine the mode of the cabin of the specific vehicle based on a result of the demand forecasting, and instruct the specific vehicle to perform a mode change to the determined mode via the server communication interface.

A vehicle dispatch method according to an embodiment of the present disclosure includes: performing demand forecasting for a plurality of services; determining, for a specific vehicle included in a plurality of vehicles, a mode of a cabin based on a result of the demand forecasting, the mode of the cabin of the specific vehicle being selectable from a plurality of modes; and instructing the specific vehicle to perform a mode change to the determined mode.

The present disclosure provides a vehicle dispatch system, a server, and a vehicle dispatch method that are capable of efficiently responding to the demands for dispatch of vehicles without the need to prepare a number of vehicles.

### BRIEF DESCRIPTION OF THE DRAWINGS

In the accompanying drawings:

FIG. 1 is a schematic diagram illustrating an example configuration of a vehicle dispatch system according to an embodiment of the present disclosure;

FIG. 2 is a block diagram illustrating an example configuration of a vehicle of FIG. 1;

FIG. 3 illustrates an example position of a cabin of the vehicle of FIG. 1;

FIG. 4 illustrates an example of services that can be provided by a plurality of vehicles;

FIG. 5 illustrates an example configuration of a server of FIG. 1;

FIG. 6 illustrates an example of vehicle management information managed by the server;

FIG. 7 is a flowchart illustrating processing for changing a mode of a specific vehicle based on demand forecasting for services;

FIG. 8 illustrates an example of information used in machine learning;

FIG. 9 illustrates an example of processing for dispatching a vehicle based on a request from a user;

FIG. 10 illustrates a vehicle dispatch system that covers a plurality of geographic areas; and

FIG. 11 illustrates processing for arranging vehicles in advance with respect to each geographic area based on demand forecasting for services.

### DETAILED DESCRIPTION

The following describes embodiments of the present disclosure with reference to the drawings. The drawings used in the following description are schematic. Dimensional ratios or the like on the drawings do not necessarily match actual ones.

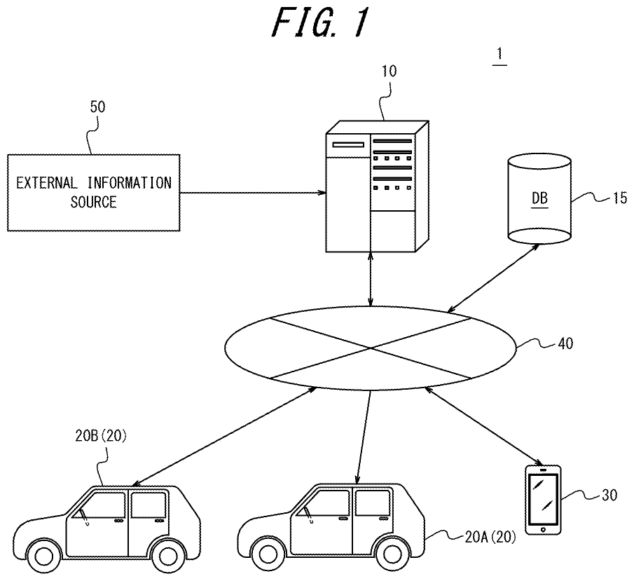

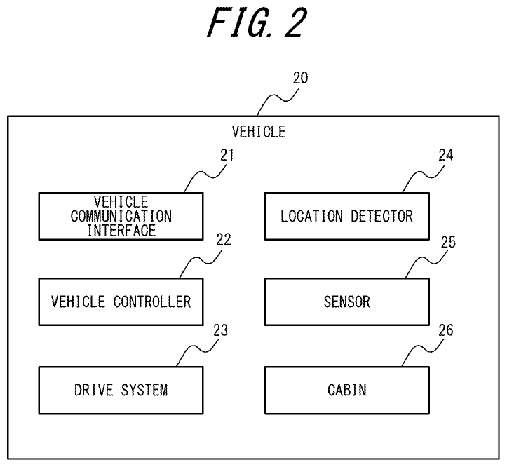

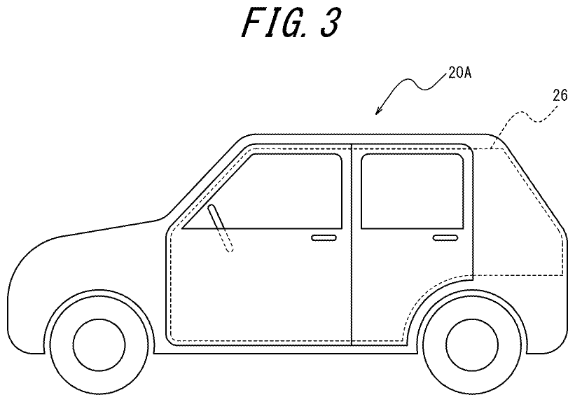

As illustrated in FIG. 1, a vehicle dispatch system 1 according to an embodiment includes a server 10 and a plurality of vehicles 20. The server 10 and the plurality of vehicles 20 are connected to a network 40 and can communicate with each other. A plurality of user terminals 30 of users who use the vehicle dispatch system 1 may also be connected to the network 40. The server 10 and the user terminals 30 may be connected by a network that is different from the network 40. A database (DB) 15 is also connected to the network 40, but this is not required. Each of the server 10 and the DB 15 is not limited to one and may be two or more in number. The vehicle dispatch system 1 includes, as some of the vehicles 20, specific vehicles 20A, in each of which a mode of a later-described cabin 26 (refer to FIG. 2 and FIG. 3) is selectable from a plurality of modes. Further, the vehicle dispatch system 1 may include general vehicles 20B other than the specific vehicles 20A. In the following, the specific vehicles 20A and the general vehicles 20B are collectively referred to as the vehicles 20.

(Vehicle Configuration)

Vehicles 20 are used for an on-demand service for providing services in accordance with service provision requests from users. The services provided by the vehicles 20 include, for example, transport of persons (hereinafter, may be referred to as “passenger transport”) and delivery of products (hereinafter referred to as “product delivery”). The vehicles 20 may include vehicles of any size and shape within the range permitted by traffic laws and regulations. For example, the vehicles 20 may be in the form of regular passenger cars or buses. The vehicles 20 may be vehicles that can operate by autonomous driving. The autonomous driving may be performed, for example, according to any level from Level 1 to Level 5 as defined by the Society of Automotive Engineers (SAE). The autonomous driving may be performed based on other definitions without being limited to the exemplified definition.

As illustrated in FIG. 2, a vehicle 20 includes a vehicle communication interface 21, a vehicle controller 22, a driving system 23, a location detector 24, a sensor 25, and a cabin 26. The respective components of the vehicle 20 are communicatively connected to each other via, for example, an in-vehicle network such as a Controller Area Network (CAN), or a dedicated line.

The vehicle communication interface 21 communicates with the server 10 via the network 40. The vehicle communication interface 21 may communicate with a user terminal 30 via the network 40 or may communicate with the user terminal 30 without using the network 40. The vehicle communication interface 21 may be, for example, an in-vehicle communication device. The vehicle communication interface 21 may include a communication module that connects to the network 40. The communication module may include, but is not limited to, a communication module compliant with a mobile communication standard, such as the 4th Generation (4G) standard or the 5th Generation (5G) standard.

The vehicle controller 22 controls the components included in the vehicle 20. Processing executed by the vehicle 20 can be referred to as processing performed by the vehicle controller 22. The vehicle controller 22 may include one or more processors. Processors include general purpose processors that execute programmed functions by loading a program, and dedicated processors that are dedicated to specific processing. Dedicated processors may include Digital Signal Processors (DSPs), Application Specific Integrated Circuits (ASICs), Field-Programmable Gate Arrays (FPGAs), and the like. The vehicle controller 22 may further include a memory. The memory can store programs executed by processors, information being operated by the processors, and the like. The memory and the processors are connected by bus lines, such as data buses or control buses. The memory may include Read Only Memory (ROM), Random Access Memory (RAM), flash memory, and the like. RAM may include Dynamic Random Access Memory (DRAM) and Static Random Access Memory (SRAM).

The driving system 23 provides a function pertaining to driving of the vehicle 20. The driving system 23 includes mechanisms, such as a motor or engine, a transmission, a steering, a brake, a chassis, tires, or the like. The driving system 23 may drive autonomously by cooperating with the location detector 24 and the sensor 25 under the control of the vehicle controller 22.

The location detector 24 acquires location information for the vehicle 20. The location detector 24 may include a receiver compliant with the Global Navigation Satellite System (GNSS). The receiver compliant with the GNSS may include, for example, a Global Positioning System (GPS) receiver. In the present embodiment, it is assumed that the vehicle 20 can acquire the location information for the vehicle 20 itself using the location detector 24. The vehicle 20 may transmit the location information for the vehicle 20 itself to the server 10 via the vehicle communication interface 21.

The sensor 25 is a sensor for detecting an external environment of the vehicle 20 that is used for autonomous driving. The sensor 25 detects persons and objects in the vicinity of the vehicle 20. The sensor 25 measures a distance from another vehicle in front of the vehicle 20 during driving. The sensor 25 includes, for example, a Light Detection and Ranging (LIDAR) sensor, a millimeter wave radar, an ultrasonic sensor, and a camera. The camera includes a stereo camera in which a plurality of cameras are arranged in the same direction. The sensor 25 may include a sensor for detecting a state within the cabin 26.

The cabin 26 is used to provide a service to a user of the vehicle 20. The cabin 26 corresponds to, for example, a portion represented by a dashed line in FIG. 3. The cabin 26 occupies a certain space in the vehicle 20. The vehicle communication interface 21, the vehicle controller 22, the driving system 23, the location detector 24, and the sensor 25 may be located outside the cabin 26.

In one embodiment, a cabin 26 of a specific vehicle 20A is configured to be at least partially convertible so as to provide varying services. For example, equipment used to provide one service may be contained in the cabin 26 in a manner such that the arrangement of the equipment may be changed from that of equipment used to provide a different service. The conversion of the cabin 26 may be made based on an instruction from the server 10 for a mode change. The conversion of the cabin 26 may be made automatically under the control of the vehicle controller 22 without assistance from a person. Alternatively, the conversion of the cabin 26 may be at least partially made manually.

In another embodiment, a cabin 26 of a specific vehicle 20A may be configured to change at least partially. For example, the cabin 26 has different units for different services to be provided, and, at the time of changing services to be provided, a unit, as a single unit, may be changed to another unit. The specific vehicle 20A may be configured to undergo a change of the cabin 26 based on an instruction from the server 10 for a mode change.

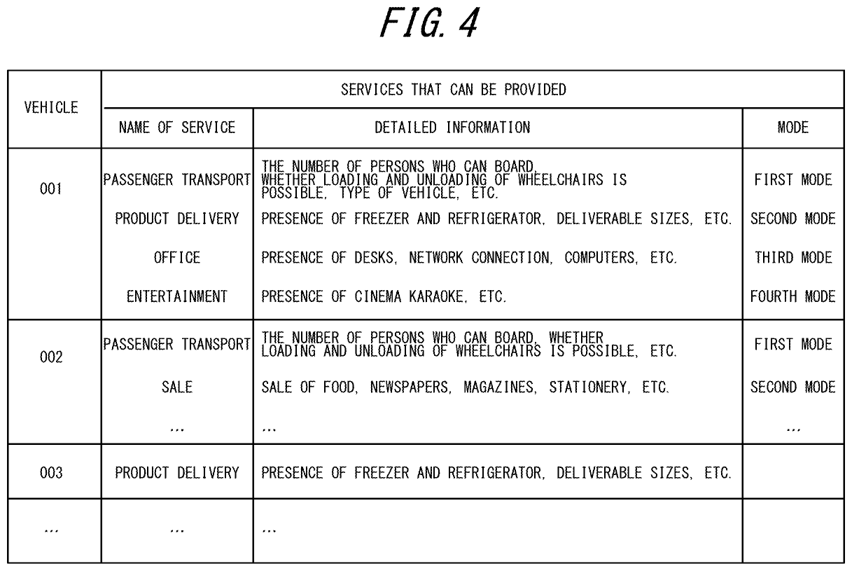

As illustrated in FIG. 4, for example, a specific vehicle 20A can provide a plurality of services as a single vehicle. In FIG. 4, a vehicle with vehicle number 001 and a vehicle with vehicle number 002 are specific vehicles 20A, and a vehicle with vehicle number 003 is a general vehicle 20B. In the example of FIG. 4, for example, the specific vehicle 20A with vehicle number 001 may provide a passenger transport service, a product delivery service, an office service, and an entertainment service.

The passenger transport service is a service for transporting one or more persons between various places. When a specific vehicle 20A provides the passenger transport service, the cabin 26 of the specific vehicle 20A is provided with seats on which persons can sit. When a specific vehicle 20A provides the passenger transport service, conditions, such as the number of persons who can board, whether loading and unloading of wheelchairs is possible, or the type of the vehicle, are determined by the size, equipment, and the like of the specific vehicle 20A. These conditions are illustrated as detailed information in FIG. 4.

The product delivery service is a service for delivering one or more products between various places. When a specific vehicle 20A provides the product delivery service, the cabin 26 of the specific vehicle 20A may be provided with equipment suited for properties of products that can be delivered. For example, when refrigerated products can be delivered, a refrigerator is provided. When frozen products can be delivered, a freezer is provided. When a specific vehicle 20A provides the product delivery service, detailed information, such as the presence of a freezer, the presence of a refrigerator, or deliverable sizes, are determined by the size, equipment, and the like of the specific vehicle 20A.

The office service is a service for providing a specific vehicle 20A as a remote office. When a specific vehicle 20A provides the office service, the cabin 26 of the specific vehicle 20A may be provided with a desk, a chair, a PC, or the like. Detailed information in this case includes the presence of desks, network connection, computers, and the like.

The entertainment service is a service for providing a specific vehicle 20A for an entertainment purpose. Services that can be provided include movie watching, karaoke, and the like. When a specific vehicle 20A provides the entertainment service, a screen, sound equipment, and the like are provided in the specific vehicle 20A.

In a specific vehicle 20A, the cabin 26 can be converted or changed for every service that is to be provided. Modes of the cabin 26 corresponding to the respective services are specified on a specific vehicle 20A basis. In FIG. 4, modes corresponding to the services that can be provided by the vehicle with vehicle number 001 are illustrated as the first mode to the fourth mode.

All of the services described above are illustrative, and a specific vehicle 20A can provide various services other than these in various manners. For example, a variety of services may be provided, such as a service for providing a rest space or an accommodation space, a service for providing food and beverages, or a service for sale of products.

Conversion or change in a specific vehicle 20A shall take a predetermined period of time. Conversion or change of a specific vehicle 20A may take, for example, several tens of minutes to several hours. Therefore, when the server 10 receives a service provision request, a specific vehicle 20A may be in a mode corresponding to the requested service.

A general vehicle 20B provides only one of the services that are described above. A general vehicle 20B may provide, among other things, the passenger transport service or the product delivery service. In the example illustrated in FIG. 4, a general vehicle 20B with vehicle number 003 provides only the product delivery service.

Information regarding the respective services that can be provided by the vehicles 20 and the modes of the cabins 26 corresponding to the services may be stored in the server 10 or in the DB 15.

(Configuration of Server)

The server 10 manages dispatch of a plurality of vehicles 20 including a specific vehicle 20A. The server 10 may manage the entire operation of the plurality of vehicles 20. The server 10 can accept various service provision requests transmitted from a plurality of user terminals 30 and dispatch vehicles 20 that are capable of providing requested services to the users. The server 10 may instruct a specific vehicle 20A to perform a mode change at an appropriate time so as to efficiently provide appropriate services to users.

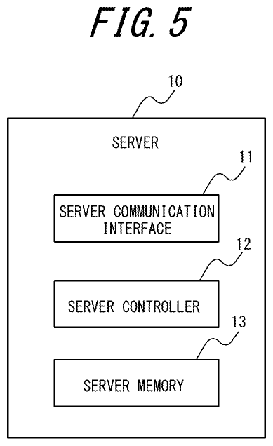

As illustrated in FIG. 5, the server 10 includes a server communication interface 11 and a server controller 12. The server communication interface 11 includes a communication module and is configured to be able to transmit/receive information to/from the plurality of vehicles 20 and the plurality of user terminals 30.

The server controller 12 controls the components included in the server 10. Processing performed by the server 10 may be referred to as processing performed by the server controller 12. The server controller 12 may include at least one processor. The server controller 12 may include various processors, as is case with the vehicle controller 22.

The server 10 may further include a server memory 13. The server memory 13 may be, but is not limited to, a semiconductor memory, a magnetic memory, or an optical memory. The server memory 13 may function as, for example, a main memory, an auxiliary memory, or a cache memory. The memory may include an electromagnetic storage medium, such as a magnetic disk. The memory may store any information used for operations of the server 10. For example, the server memory 13 may store a system program, an application program, and the like. The server 10 may store a program, information, and the like, using the DB 15 as the memory. The server memory 13 may be included in the server controller 12.

The server controller 12 may store, in the server memory 13 or in DB 15, the information regarding the respective services that can be handled by the vehicles 20 as illustrated in FIG. 4, in association with the modes of the cabins 26 of the vehicles 20. The server controller 12 may search the information regarding the respective services that can be provided by the vehicles 20 according to a predetermined condition. Correspondence relationships between the vehicles 20 and the services and modes that can be provided by the vehicles 20 are not limited to the format illustrated in FIG. 4, and can be stored in various formats.

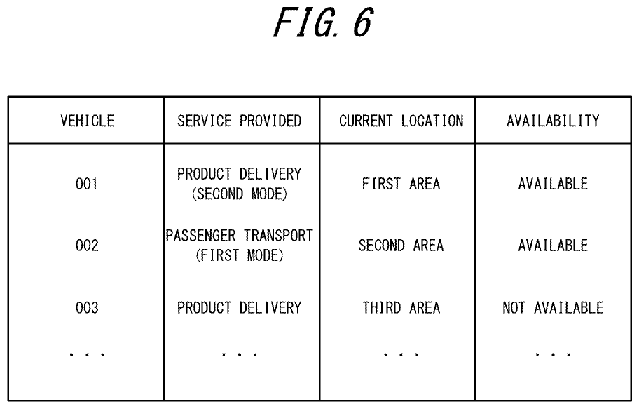

The server controller 12 may cause the server memory 13 or the DB 15 to store information (hereinafter, referred to as vehicle status information) indicating, for each vehicle 20, a current status, for example as illustrated in FIG. 6. Information indicating the current status of a vehicle 20 may include, for example, information regarding “service provided”, “current location”, and “availability” of the vehicle 20. The “service provided” of the vehicle 20 is a service that can be currently provided by the vehicle 20 and that corresponds to the current mode of the vehicle 20. The “current location” of the vehicle 20 indicates the current location of the vehicle based on the location information detected by the location detector 24. The “current location” of the vehicle 20 may include information indicating a geographic area of an extent and/or information indicating a point, such as a latitude and longitude. The server controller 12 may acquire the information regarding the current location from the vehicle 20 via the server communication interface 11. The “availability” refers to information indicating whether the vehicle 20 is currently available. The vehicle 20 is “not available” when the vehicle 20 is providing a service to a user. The vehicle 20 is “available” when the vehicle 20 is in a standby state without providing a service to a user. The server controller 12 may acquire the information regarding the “availability” from the vehicle 20 via the server communication interface 11.

The server controller 12 can perform demand forecasting for a plurality of services, and determine a mode of a cabin 26 of a specific vehicle 20A based on a result of the demand forecasting. The server controller 12 may instruct the specific vehicle 20A to perform a mode change to the determined mode via the server communication interface 11. The server controller 12 can change the mode of the specific vehicle 20A in advance based on the demand forecasting for the services, thereby enhancing the availability of the plurality of vehicles 20 as a whole. This reduces a waiting time for users to use the vehicle dispatch system 1. Further, from the perspective of an operator of the vehicle dispatch system 1, the usage efficiency of the vehicles 20 can be improved.

(User Terminal)

A user terminal 30 is, for example, an information terminal including an input/output interface, an information processor, a communication interface, and a location detector. As the user terminal 30, for example, a mobile information terminal, such as a smartphone, may be used. The input/output interface includes, for example, a liquid crystal display with a touch panel. The user terminal 30 can receive an input from the user through the input/output unit and display, to the user, information processed by the user terminal 30. The information processor is configured with a processor. The information processor executes various types of information processing in the user terminal 30. The communication interface is configured with, for example, a wireless communication module compatible with a communication method for the network 40. The user terminal 30 can communicate with the server 10 via the network 40 using the communication interface. The user terminal 30 may communicate with a vehicle 20 via the network 40. As is case with the location detector 24 included in the vehicle 20, for example, the location detector may include a global positioning system receiver. The location detector can detect the location of the user terminal 30 itself.

The user terminal 30 may run an application that is used to use the service provided by the vehicle dispatch system 1. In accordance with the application, the user terminal 30 can handle input of information from the user, output of information to the user, and transmission and receipt of information to and from the server 10. The user terminal 30 may also be used for communications with a vehicle 20 dispatched in response to a service provision request from the user.

(Processing for Changing Mode of Vehicle Based on Demand Forecasting)

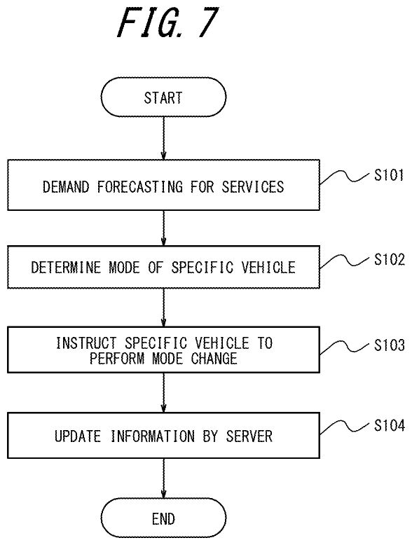

A vehicle dispatch method according to the present disclosure will be described with reference to the flowchart of FIG. 7. The flowchart of FIG. 7 illustrates processing for changing a mode of a vehicle based on demand forecasting for services that is performed by the server 10. This processing may be performed during a time period of the day before the trend of service usage of users is likely to change. For example, this processing may be performed during a predetermined time period, such as before typical commute hours, before the noon, or in the evening. This processing may also be performed at a time when services are less frequently provided by vehicles 20. For example, this processing may be performed late at night due to an expected demand for services during the daytime.

First, the server controller 12 of the server 10 performs the demand forecasting for the respective services that can be provided by the vehicles 20 (Step S101). For example, the demand forecasting may be performed by considering date and time information for targets of the forecasting, weather information, and/or event holding information, as factors (hereinafter, also referred to as affecting factors) that affect the demand forecasting. The date and time information may include a time of the day, a day of the week, a date (month and day), a season, and the like. The weather information may include forecast information about the weather, temperature, humidity, and the like. The event holding information may include festivals, school events, concerts, and the like in an area targeted in the forecasting. The server 10 may acquire information regarding the affecting factors from an external information source 50 that is not included in the vehicle dispatch system 1. The external information source 50 includes an information provider or the like that provides weather information and/or event information. The server 10 may acquire information from the external information source 50 via a dedicated line or via the network 40.

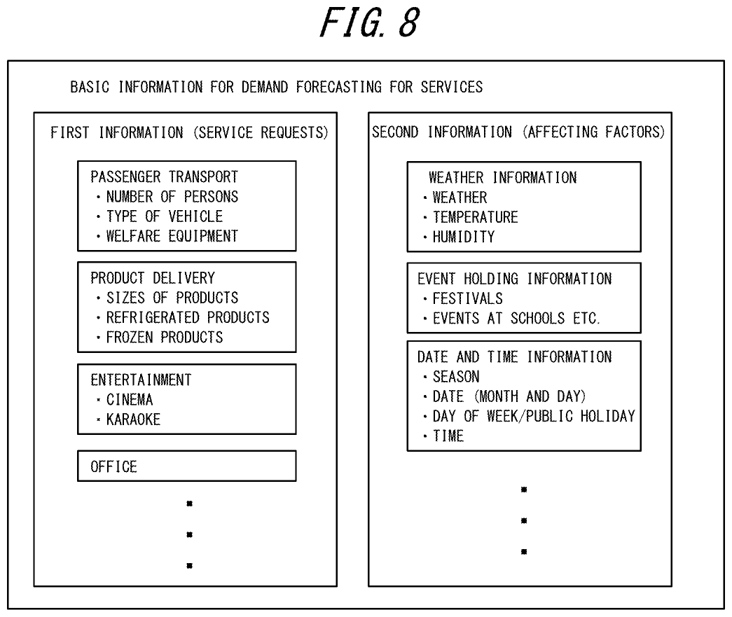

The server controller 12 may use machine learning to forecast services that are likely to be demanded under various affecting factors. For example, as illustrated in FIG. 8, the server controller 12 may store, in the server memory 13 or in the DB 15, first information that is information regarding past service provision requests and second information that indicates affecting factors associated with the service provision requests, as training data. The first information includes each type of service that has been requested to be provided, such as the passenger transport service or the product delivery service, and detailed information of the service. The detailed information includes, for example, the number of persons who use the passenger transport service, the type of a vehicle 20 that is desired for use (e.g., distinction between a sports car and a sedan, etc.), and the like. The server controller 12 learns a correspondence relationship between the first information and the second information by machine learning based on the training data. The server controller 12 performs the demand forecasting for the services using information regarding the correspondence relationship between the first information and the second information obtained by the machine learning, based on information, such as a date and time at which the services are to be provided, the weather forecasted, and events scheduled to be held, and the like.

The machine learning does not need to be performed by the server 10. The operator of the vehicle dispatch system 1 can also load the first information and the second information into an information processing apparatus other than the server 10, so as to make the information processing apparatus learn the correspondence relationship between the first information and the second information. The server controller 12 can use a result of the learning by the other information processing apparatus as a learning model.

The demand forecasting for the services may be performed in various ways other than by using machine learning. As a result of the demand forecasting for the services, the server controller 12 determines, for each service, the number of vehicles 20 required to provide the service that is predicted to be requested for the target date and time.

Subsequent to Step S101, the server controller 12 determines a mode of a specific vehicle 20A (Step S102). The server controller 12 determines a mode of a specific vehicle 20A so that the services can be provided most efficiently to respond to forecasted service demand. When, for instance, the number of vehicles 20 that provide the passenger transport service is insufficient for the forecasted service demand, the server controller 12 causes modes of some specific vehicles 20A to undergo a mode change so as to provide the passenger transport service. When, for another instance, the number of vehicles 20 that provide the product delivery service is insufficient for the forecasted service demand, the server controller 12 causes modes of some specific vehicles 20A to undergo a mode change so as to provide the product delivery service. The server controller 12 may determine a mode of a specific vehicle 20A so that the number of specific vehicles 20A that undergo a mode change can be minimized.

The server controller 12 may further consider the detailed information. When, for instance, it is determined from the demand forecasting for the services that there is a high demand for the passenger transport service for a large number of persons, such as five or more persons, a large specific vehicle 20A may be allocated to the passenger transport service. When, for another instance, the demand forecasting for the services predicts an increase in delivery of frozen products, the server controller 12 may allocate, to the product delivery service, a specific vehicle 20A that can be equipped with a freezer.

After determining a mode of a specific vehicle 20A in Step S102, the server controller 12 instructs a specific vehicle 20A in need of a mode change to perform the mode change, via the server communication interface 11 and via the network 40 (Step S103). A specific vehicle 20A that has been instructed to perform a mode change performs the mode change to a specified mode. The mode change of the specific vehicle 20A may be performed automatically by the vehicle controller 22 in response to an instruction from the server controller 12, or may be at least partially performed manually. Upon completion of the mode change, the vehicle controller 22 may notify the server 10 of this via the vehicle communication interface 21 and via the network 40.

Subsequent to Step S103, the server controller 12 may change, for a specific vehicle 20A that has undergone a mode change, the “service provided” information in the vehicle status information to the current service to be provided (Step S104).

This allows the server 10 to forecast what services will be demanded in various time periods and dispatch more vehicles 20 that can provide the forecasted services. For example, the server 10 may allocate more vehicles 20 that can provide the passenger transport service between 7:00 and 9:00 and between 16:00 and 18:00 for drop-off and pick-up of office and school commuters. Further, more vehicles 20 that can provide a delivery service for food may be dispatched after 18:00. Moreover, the proportion of vehicles 20 to be dispatched can be changed depending on the time period, the day of the week, the season, or the like. Moreover, when, for example, it is likely that the temperature on the following day will be high, the server 10 may dispatch more vehicles 20 that can provide the product delivery service in which frozen or refrigerated products may be delivered.

(Vehicle Dispatch Processing in Response to Request from User)

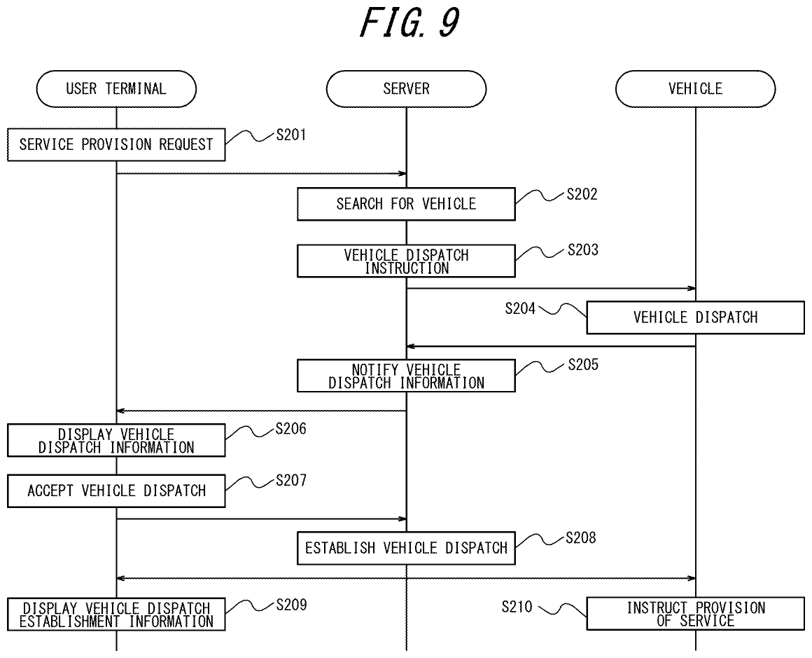

With reference to the flowchart of FIG. 9, the vehicle dispatch method according to the present disclosure will be further described. FIG. 9 illustrates an example of processing when the server 10 receives a service provision request from a user.

First, a user operates the user terminal 30 to make a service provision request to the server 10 (Step S201). The user uses the user terminal 30 to specify a service requested to be provided and to designate information required. For example, when the product delivery service is requested, the information required includes information regarding a point of origin and a destination, information regarding whether refrigerated products or frozen products are included, sizes of products to be delivered, and the like.

Upon receiving the service provision request from the user terminal 30, the server 10 searches for a vehicle 20 capable of providing the service that is requested by the user to be provided (Step S202). The search can be performed by the server controller 12 searching the vehicle status information stored in the server memory 13 or in the DB 15. For example, when searching the vehicle status information illustrated in FIG. 6 in response to a request from the user for the product delivery service, the server controller 12 can perform the search, and extract and select the specific vehicle 20A with vehicle number 001 that corresponds to the product delivery service and that is currently available.

The server 10 subsequently transmits, to a vehicle 20 selected by the search, a vehicle dispatch instruction to provide the service to the user (Step S203). Upon receiving the vehicle dispatch instruction, in a case in which the service can be provided, the vehicle controller 22 of the vehicle 20 notifies the server 10 that the vehicle dispatch is possible (Step S204). In a case in which the vehicle dispatch is not possible, the vehicle 20 informs the server 10 that the vehicle dispatch is not possible. In this case, the server 10 needs to return to the Step S202 to search for a vehicle again. In FIG. 9, a flow in the case in which the vehicle dispatch is not possible is omitted and not illustrated.

Upon receiving from the vehicle 20 a response indicating that the vehicle dispatch is possible, the server 10 informs the user terminal 30 of vehicle dispatch information for the vehicle 20 (Step S205). The vehicle dispatch information may include information regarding a departure time, an arrival time, and/or a fare.

Upon receiving the vehicle dispatch information from the server 10, the user terminal 30 displays the vehicle dispatch information on the input/output interface (Step S206). In a case in which the user accepts the vehicle dispatch, the user operates the user terminal 30 and transmits the acceptance of the vehicle dispatch to the server 10 (Step S207).

Upon receiving the acceptance of the vehicle dispatch from the user terminal 30, the server 10 establishes the vehicle dispatch (Step S208). When the dispatch is established, the server 10 sets the “availability” information to “not available” in the vehicle status information stored in the server memory 13 or in the DB 15. Further, the server 10 causes the user terminal 30 to display vehicle dispatch establishment information indicating that the vehicle dispatch has been established (Step S209). The server 10 also instructs the vehicle 20 to provide the service (Step S210).

As described above, with a specific vehicle 20A having a plurality of services that can be provided, the vehicle dispatch system 1 according to the present embodiment can respond to demand for many types of services.

Further, the vehicle dispatch system 1 performs the demand forecasting for the services that can be requested by the users by using information regarding the affecting factors, such as dates and times at which the services are to be provided, the weather, or events, and changes a mode of a specific vehicle 20A based on a result of the demand forecasting. This increases the likelihood of providing the services to the users without excessively increasing the number of vehicles 20 and also improves the usage efficiency of the plurality of vehicles 20 as a whole including the specific vehicles 20A.

Further, the vehicle dispatch system 1 according to the present embodiment uses, as an example, the first information that is information regarding past service requests and the second information that indicates the affecting factors for occasions when the service requests included in the first information have been received, so that the correspondence relationship between the affecting factors and service request information may be learned by machine learning. This can increase accuracy of the demand forecasting for the services.

(Vehicle Dispatch System that Covers Plurality of Geographic Areas)

In another embodiment of the present disclosure, the vehicle dispatch system 1 may cover a plurality of geographic areas. The server 10 of the vehicle dispatch system 1 may perform dispatch of vehicles 20 with respect to the plurality of geographic areas. The plurality of geographic areas may include, for example, different administrative divisions, urban areas of different cities, or the like. In those cases, the server controller 12 performs, with respect to each of the plurality of geographic areas, demand forecasting for services and determines, with respect to each of the plurality of geographic areas, an arrangement of a plurality of vehicles 20 based on a result of the demand forecasting for the services. Based on the determined arrangement of the plurality of vehicles 20, the server controller 12 may instruct one or more vehicles 20 included in the plurality of vehicles 20 to travel to the corresponding geographic area in the plurality of geographic areas.

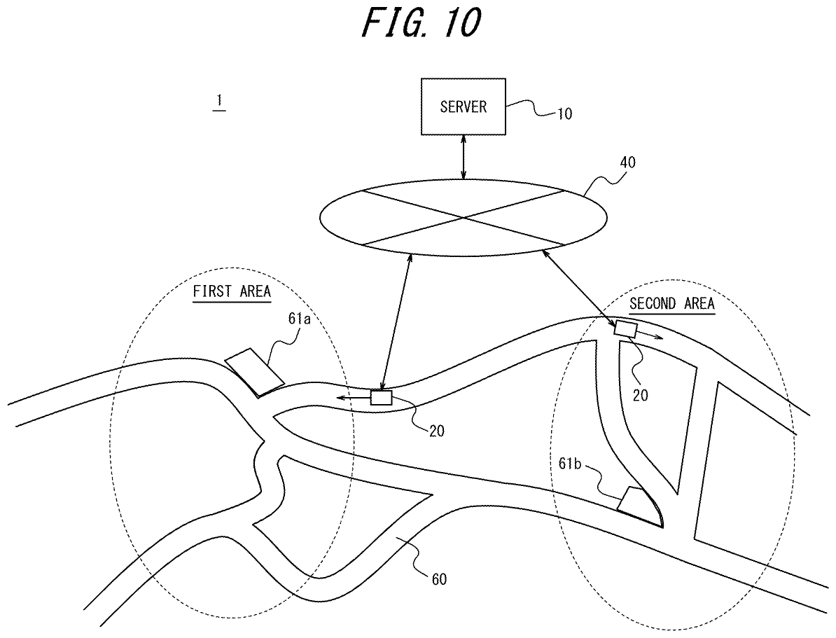

FIG. 10 illustrates an example of the vehicle dispatch system 1 that covers a plurality of geographic areas. In the example of FIG. 10, the vehicle dispatch system 1 covers the plurality of geographic areas including a first area and a second area, each illustrated as being surrounded by a dashed line, as areas to which vehicles 20 can be dispatched. The first area and the second area are connected by one or more roads 60. In FIG. 10, the DB 15, the user terminal 30 and the external information source 50 are omitted. When the server 10 receives a service provision request from a user terminal 30, the server 10 dispatch a vehicle 20 located in the same geographic area. For instance, when receiving a service provision request from a user terminal 30 in the first area, the server 10 dispatches a vehicle 20 located in the first area.

The server 10 may cause a vehicle 20 to travel in advance based on the demand forecasting for the services for a certain geographic area. When, for instance, it is forecasted that there will be many requests for the product delivery service for refrigerated products in the first area, the server 10 may cause a vehicle 20 that has an included or provided freezer and is capable of providing the delivery service to travel to a standby location 61a in the first area in advance. When, for another instance, it is forecasted that there will be many requests for the passenger transport service at a certain time because an event is going to be held in the second area, the server 10 may cause a vehicle that provides the passenger transport service to travel to a standby location 61b in the second area.

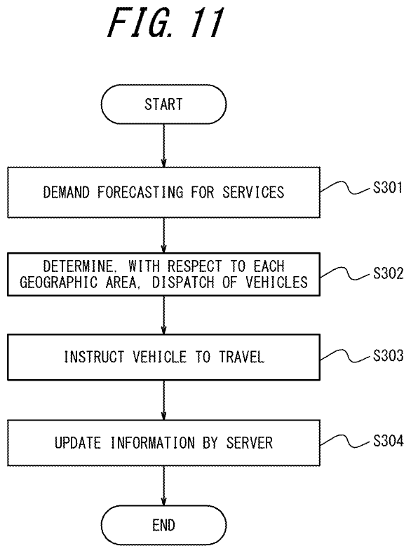

With reference to the flowchart of FIG. 11, the vehicle dispatch method of the vehicle dispatch system 1 according to the present disclosure will be further described. FIG. 11 illustrates processing executed by the server controller 12 of the server 10 in the vehicle dispatch system 1 that covers the plurality of geographic areas.

First, the server controller 12 of the server 10 performs the demand forecasting for the services that can be provided by the vehicles 20 (Step S301). This demand forecasting produces a forecast of service demand per geographic area covered by the vehicle dispatch system 1. A method for the demand forecasting is similar to that in Step S101.

Subsequent to Step S301, the server controller 12 determines, with respect to each geographic area, dispatch of the vehicles 20 (Step S302). In Step S302, the respective services that can be provided by the specific vehicles 20A included in the plurality of vehicles 20 are considered. That is, the server controller 12 also determines a mode of a specific vehicle 20A, along with an arrangement of the vehicles 20. Based on the demand forecasting for the services, the server controller 12 determines the arrangement of the vehicles 20 so that the usage efficiency of the vehicles 20 can be improved across all the geographic areas. The server controller 12 may determine the arrangement of the vehicles 20 so that the usage efficiency of the vehicles 20 can be maximized across all the geographic areas.

After determining the arrangement of the vehicles 20 by Step S302, the server controller 12 instructs a vehicle 20 that needs to travel across geographic areas to travel, via the server communication interface 11 and the network 40 (Step S303). Further, the server controller 12 instructs a specific vehicle 20A that needs a mode change to perform the mode change.

Subsequent to Step S303, the server controller 12 changes, for a vehicle 20 that has travelled across geographic areas, the “current location” information in the vehicle status information (Step S304). In this case, the “current location” information may include information specifying a geographic area, such as the first area or the second area. Further, the server controller 12 changes the “service provided” information for a specific vehicle 20A that has undergone a mode change.

In this way, based on the demand forecasting for the services, the vehicle dispatch system 1 can have more vehicles 20 on standby in the respective geographic areas so that the services that are likely to be requested can be provided. This can increase the usage efficiency of the vehicles 20 in the entire vehicle dispatch system 1.

Additionally, the present disclosure is not limited to the above embodiments, and various modifications and revisions may be implemented. For example, functions or the like included in each means, each step, or the like can be rearranged without logical inconsistency, and a plurality of means, steps, or the like can be combined together or divided.

The methods disclosed herein can be performed according to a program by a processor included in the server 10. Such a program may be stored in a non-transitory computer readable medium. Examples of non-transitory computer readable media may include, but are not limited to, a hard disk, RAM, ROM, flash memory, a CD-ROM, an optical storage device, and a magnetic storage device.

1. A vehicle dispatch system comprising:
a server; and
a plurality of vehicles, wherein
each vehicle in the plurality of vehicles includes a vehicle communication interface configured to be able to transmit/receive information to/from the server, and a cabin used for a service to a user,
the plurality of vehicles include a specific vehicle, a mode of the cabin of the specific vehicle being selectable from a plurality of modes, and the server includes a server communication interface configured to be able to transmit/receive information to/from the plurality of vehicles, and a server controller configured to perform demand forecasting for a plurality of services, determine the mode of the cabin of the specific vehicle based on a result of the demand forecasting, and instruct the specific vehicle to perform a mode change to the determined mode via the server communication interface.

2. The vehicle dispatch system according to claim 1, wherein
the plurality of services include transport of a person and delivery of a product.

3. The vehicle dispatch system according to claim 1, wherein
the cabin of the specific vehicle is configured to be at least partially convertible, and is converted based on an instruction from the server for the mode change.

4. The vehicle dispatch system according to claim 1, wherein
the cabin of the specific vehicle is configured to change at least partially, and undergo a change of the cabin based on an instruction from the server for the mode change.

5. The vehicle dispatch system according to claim 1, wherein
the server controller performs the demand forecasting by considering date and time information, weather information, and/or event holding information.

6. The vehicle dispatch system according to claim 1, further comprising
a database configured to store a correspondence relationship between the plurality of services and a plurality of modes for the cabins of the plurality of vehicles.

7. The vehicle dispatch system according to claim 1, wherein
the server communication interface is configured to be able to receive a service provision request from a user terminal, and the server controller is configured to select a vehicle in the plurality of vehicles based on the service provision request.

8. The vehicle dispatch system according to claim 7, wherein
the server controller is configured to cause first information and second information to be stored as training data, the first information being information regarding past service provision requests, and the second information including date and time information, weather information, and/or event holding information associated with the service provision requests, learn a correspondence relationship between the first information and the second information by machine learning based on the training data, and perform the demand forecasting based on information regarding the correspondence relationship obtained by learning.

9. The vehicle dispatch system according to claim 1, wherein
the server controller is configured to perform the demand forecasting for the plurality of services with respect to a plurality of geographic areas, determine, with respect to each geographic area in the plurality of geographic areas, an arrangement of the plurality of vehicles based on a result of the demand forecasting, and instruct one or more vehicles included in the plurality of vehicles to travel to the corresponding geographic area in the plurality of geographic areas based on the determined arrangement of the plurality of vehicles.

10. A server for use in a vehicle dispatch system including the server and a plurality of vehicles, the server comprising:
a server communication interface configured to be able to transmit/receive information to/from the plurality of vehicles, the plurality of vehicles including a specific vehicle, a mode of a cabin of the specific vehicle being selectable from a plurality of modes, the cabin being used for a service to a user; and
a server controller configured to perform demand forecasting for a plurality of services, determine the mode of the cabin of the specific vehicle based on a result of the demand forecasting, and instruct the specific vehicle to perform a mode change to the determined mode via the server communication interface.

11. The server according to claim 10, wherein
the plurality of services include transport of a person and delivery of a product.

12. The server according to claim 10, wherein
the server controller performs the demand forecasting by considering date and time information, weather information, and/or event holding information.

13. The server according to claim 10, comprising
a database configured to store a correspondence relationship between the plurality of services and a plurality of modes for the cabins of the plurality of vehicles.

14. The server according to claim 10, wherein
the server communication interface is configured to be able to receive a service provision request from a user terminal, and the server controller is configured to select a vehicle in the plurality of vehicles based on the service provision request.

15. The server according to claim 14, wherein
the server controller is configured to cause first information and second information to be stored as training data, the first information being information regarding past service provision requests, and the second information including date and time information, weather information, and/or event holding information associated with the service provision requests, learn a correspondence relationship between the first information and the second information by machine learning based on the training data, and perform the demand forecasting based on information regarding the correspondence relationship obtained by learning.

16. The server according to claim 10, wherein
the server controller is configured to perform the demand forecasting for the plurality of services with respect to a plurality of geographic areas, determine, with respect to each geographic area in the plurality of geographic areas, an arrangement of the plurality of vehicles based on a result of the demand forecasting, and instruct one or more vehicles included in the plurality of vehicles to travel to the corresponding geographic area in the plurality of geographic areas based on the determined arrangement of the plurality of vehicles.

17. A vehicle dispatch method comprising:
performing demand forecasting for a plurality of services;
determining, for a specific vehicle included in a plurality of vehicles, a mode of a cabin based on a result of the demand forecasting, the mode of the cabin of the specific vehicle being selectable from a plurality of modes; and
instructing the specific vehicle to perform a mode change to the determined mode.

18. The vehicle dispatch method according to claim 17, wherein
the plurality of services include transport of a person and delivery of a product.

19. The vehicle dispatch method according to claim 17, further comprising:
acquiring a service provision request from a user terminal; and
selecting a vehicle in the plurality of vehicles based on the service provision request.

20. The vehicle dispatch method according to claim 17, wherein
performing the demand forecasting for the plurality of services includes:
causing first information and second information to be stored as training data, the first information being information regarding past service provision requests, and the second information including date and time information, weather information, and/or event holding information associated with the service provision requests; and
learning a correspondence relationship between the first information and the second information by machine learning based on the training data, and performing the demand forecasting based on information regarding the correspondence relationship.
